(19) United States
(12) Patent Application Publication
(10) Pub. No.: US 2003/0019089 A1
(43) Pub. Date: Jan. 30, 2003

(54) Method for the production of a patterned textile surface

(75) Inventor: Ralf Winter, Grossenlueder (DE)

Correspondence Address: FOLEY AND LARDNER, SUITE 500, 3000 K STREET NW, WASHINGTON, DC, 20007, US

(73) Assignee: FILZFABRIK FULDA GMBH & CO.

(21) Appl. No.: 10/187,448

(22) Filed: Jul. 2, 2002

(30) Foreign Application Priority Data
Jul. 3, 2001 (DE) 101 32 103.1

(51) Int. Cl. B32B 5/06; D06C 23/00

(52) U.S. Cl. 28/104; 28/108

(57) ABSTRACT

A method is disclosed for the production of a textile surface construction of at least one base layer and mesh-needled to the base layer a useful surface layer showing an optically non-uniform, substantially rapport-free upper side. Apart from staple fibers, the upper side contains a multitude of stochastically distributed fiber elements with a pre-selected, possible variable geometric form, which distinguish from the staple fibers in terms of color and/or fiber characteristics. In addition, the present invention relates to a textile surface construction which is produced by such a method.

### CROSS-REFERENCE TO RELATED PATENT APPLICATIONS

Federal Republic of Germany Priority Application 101 32 103.1, filed Jul. 3, 2001 including the specification, drawings, claims and abstract, is incorporated herein by reference in its entirety.

### FIELD OF THE INVENTION

The present invention relates to a method or process for the production of a textile surface construction of at least one base layer and mesh-needled to the base layer a useful surface layer showing an optically non-uniform, substantially rapport-free upper side, which apart from staple fibers contains a multitude of stochastically distributed fiber elements with a pre-selected, possible variable geometric form, which distinguish from the staple fibers in terms of color and/or fiber characteristics. In addition, the present invention relates to a textile surface construction which is produced by such a process and in this way can be used, for example, as a floor covering, doormat, decorating-material, lining material or similar surface coverings.

### BACKGROUND OF THE INVENTION

Textile surface constructions, in particular fleece webs made from staple fibers, are conventionally manufactured by means of mechanical or aerodynamic processes.

In the case of the mechanical carding process, first a staple fiber nap or pile is formed on carding machines, which afterwards will be paneled by means of a cross-layer. Then the paneled carding pile can be fixed mechanically and/or chemically and/or thermally, so that the fleece webs can be produced with high abrasion strength, that can be used for example as floor coverings or wall coverings.

In case of the known aerodynamic processes, fleece webs are produced that do not show high strength. In this respect staple fibers that have been previously mechanically separated are introduced into a strong air stream that, for example, is blown against a rotating and perforated drum, on whose surface the fibers constitute a randomly laid fleece, whereas the air is sucked off by the openings in this drum. Because of the deficient strength of the fleece webs produced in such a way, the aerodynamic process is not suitable for the production of floor covering materials, but rather it is used exclusively for the production of textile surface constructions for which high abrasion strength is not important, for example, such materials that are used in upholstery.

For the production of optically non-uniform, especially non-uniform in color, textile surface constructions, suitable colored fiber elements can be added to the staple fibers before the fleece construction. However, during the production, especially according to the mechanical carding process, the disadvantage arises that the fiber elements are at least partially destroyed during the carding process.

DE 39 04 526 A1 discloses a process for the production of a floor covering material consisting of two needle fleece layers, in which the upper layer shows a three-dimensional relief-like surface structure. In order to avoid damage to this relief structure in the final needling-step, the lower layer is needled to the lower side of the upper layer, however only up to a depth of the upper layer that is smaller than the thickness of the non-structured base element of the upper layer. This process requires a final impregnation of both layers with binding agents and is suitable only for those fleece webs whose upper and base layers exist as needle-fleece.

In EP 0 01 3 426 B1 a textile surface construction is described consisting of a fiber containing base layer, formed as contrast layer, as well as an upper layer composed of a quantity of individual endless-filaments mesh-needled with the base layer. In this product the endless-filaments are arranged on the contrast base layer at a distance one from the other in such a way that the contrast base layer becomes visible through the spacing between these endless-filaments. The surface structure of this surface construction however is not rapport-free and moreover is limited to stripe-shaped patterns because of the endless-filaments.

EP 0 013 428 B1 discloses a textile surface construction with a non-woven fiber layer, which contains a plurality of fiber structures that are delimited one from the other and that consist of spherically wound fibers, the so-called “ball-thread” (“Kugelgarne”), that are fixed by means of needling-fibers. In order to find use as wall covering or floor covering material, such a fiber construction layer containing a ball thread is also needled to a base layer, wherein the base layer can be either a passively needle-capable surface construction, for example, a plastic film, a grid-film or mesh net, or an active needle-capable surface-construction. By the active needling, however, the ball-threads become more or less strongly compressed, so that flattened structures will be obtained, rather felt-like constructions with an impaired high/deep structure.

In order to partially overcome these disadvantages, a textile surface construction is proposed in EP 0 053 701 B1 in which the upper-layer containing the ball-threads is not fixed, so that the ball-threads are present without mutual cohesive holding and are fixed only at the base layer by holding fibers. Also in the case of this process the production of rapport-free surfaces is possible, if at all, with only a relatively high expenditure.

WO 98/30745 discloses a process for the production of a surface construction with a substantially rapport-free and optically non-uniform upper side. In this process, first, preferably differently colored elements, and subsequently at least partially the elements from which the useful layer is formed, having different geometrical shapes, are introduced into a setting device, where they are uniformly distributed. Next, the elements are applied in an application current onto a base layer, in order to be uniform finally with the base layer, preferably by needling. Since in case of this process the colored elements are strongly compressed more or less by the concluding needling process and are thereby changed in their form, only color-weakened and diffused surface patterns are obtained.

### SUMMARY OF THE INVENTION

One object of the present invention is to provide an improved method for manufacturing a patterned textile surface material.

A further object of the invention is to provide an improved textile surface material.

In accordance with one aspect of the present invention, there has been provided a method for the production of a textile surface construction comprised of at least one base layer and a useful layer mesh-needled to the base layer, the useful layer having an optically non-uniform, substantially report-free upper side and comprising staple fibers and a plurality of stochastically distributed fiber elements also having a predetermined and optionally different geometric form which is distinguished in its color and/or its fiber characteristics from the staple fibers, the method comprising: a) forming a fleece web of staple fibers and said fiber elements, wherein the fiber elements are arranged predominantly on one side of the useful layer; b) applying the side of the fleece web opposite to the fiber elements to the base layer; and c) needle-working the fleece web to the base layer at least one time, in such a way that the fleece web constitutes the useful layer.

In accordance with another aspect of the invention, there is provided an improved textile surface construction made by the method defined above.

Further objects, features and advantages of the present invention will become apparent from the detailed description of preferred embodiments that follows, when considered together with the accompanying figures of drawing.

### BRIEF DESCRIPTION OF THE DRAWINGS

FIG. 1 is a schematic representation, in cross section, of a reinforced fleece web preferably obtained as an intermediate product according to the process of the invention;

FIG. 2 is a schematic representation, in cross section, of a textile surface construction produced according to the process of the invention; and

FIG. 3 is a schematic representation, in cross section, of a textile surface construction produced according to prior art.

### DETAILED DESCRIPTION OF THE PREFERRED EMBODIMENTS

The invention provides a process for the production of a textile surface construction with an optically non-uniform and substantially rapport-free surface, in which case the fiber elements for obtaining this, possibly colored pattern are neither changed in their form nor in their structure, so that the surfaces will be rich in contrast and structure. In the process for the production of a textile surface construction of the above-mentioned type, the fiber elements formed as staple fibers and optionally fiber-aggregates are formed into a reinforced fleece web, in which the fiber elements are arranged predominantly on one side of the fleece web. The reinforcement of the fleece web can take place with a mechanical and/or chemical and/or thermal process. Finally, the reinforced fleece web is applied to the base layer and then is needled with the base layer, possibly several times, in such a way that the fleece web constitutes the abrasion-resistant useful layer.

Surprisingly, it has shown that, by the disposition of the fiber elements at the surface on the opposite side of the base layer, only a small degree of deformation and disintegration of the structure of the fiber elements takes place during the subsequent needling of the fleece web with the base layer. This is true even if the fiber elements are formed, as preferred, as a fiber-aggregate. Thus, in a simple way the textile surface construction can be obtained with an optically non-uniform structured surface rich in contrasts, which is different from the prior art, and which nevertheless shows a high abrasion strength and thus, for example, can also be used as floor covering material. The patterning of the textile surface construction according to the invention can be adjusted by choosing the size, the type of fiber, the form and the color of the fiber elements or fiber aggregate, respectively. Moreover the required rapport-free surface of the textile construction can be achieved.

Basically, there can be used for the production of the reinforced fleece web from the staple fibers and the fiber elements any production process for fleece webs known by the artisan, which can be modified in such a way that the disposition of the fiber elements is substantially on one side of the fleece web. Preferably, however, this is achieved by an aerodynamic process step, in which the mixture of suitable staple fibers and suitable fiber elements is introduced into an air stream and this air stream is blown against a collecting surface, for example, against a perforated, rotating drum, on whose surface the fibers form the fleece, whereas the air is sucked off by the openings of this collecting surface. Because of the differences in the aerodynamic properties and the specific weight between the staple fibers and the fiber elements, the more compact and heavier fiber elements are deposited at irregular distances from one another directly at the surface of the perforated collecting surface, whereas the lighter staple fibers lay mainly between and on the fiber elements and constitute a continuous fleece layer. In the case of such an aerodynamic process there is a small mechanical load of the fiber elements, even if, as preferred, they are formed as fiber-aggregates, so that they are changed only a small amount in their form and structure, and they come to lie on one side of the fleece-web without special measures.

If the production of the possibly reinforced fleece web takes place by an aerodynamic process, preferably previously mechanically produced staple fibers are used, so that the single staple fibers show substantially uniform aerodynamic properties.

A further advantage of the application of an aerodynamic process for the construction of the possibly reinforced fleece web consists in the integration of a mixing device for mixing of the staple fibers and the, for example, other color fiber elements before the fleece construction step. This can be realized in the way that, first, air is introduced into a mixing device that contains the staple fibers and the fiber elements, where they are whirled by appropriate conventional devices in a way that leads to a complete mixing of the staple fibers and the fiber elements. One part of this air stream containing the mixture of staple fibers and fiber elements can then be led away continuously by a screen aperture of the mixing device and then carried to the device for the production of the fleece web. In such a step, the air stream is transformed preferably into a laminar stream and is blown against the perforated collecting surface. The collecting surface can be formed, for example, by a rotating drum.

In contrast to such a continuous process, it is also possible to use a discontinuously activated mixing device, which contains a suitable straightened mesh net or grid, for collecting the staple fibers and the fiber elements. For mixing of the starting materials, a short-duration air stream is introduced into the mixing device, on the side which is oriented away from the starting materials, and is led through the mesh-net or grids respectively, by which the staple fibers and the fiber elements are carried away by the air-current and are mixed completely. After the end of the air stream pulses, the mixture deposits then on the mesh-net or grids and can be mechanically removed from the mixing device and led to the device for fleece formation, which is fed by a separate air stream.

For mixing the staple fibers and the fiber elements, however, any other process known by the artisan for this purpose can be used.

Preferably, for the production of the reinforced fleece web according to the invention, staple fibers consisting of polypropylene, polyester, polyamide or viscose are used. Of course, the invention is not limited to any particular type of fiber.

The patterning of the textile surface construction is determined mainly by the size, type of fiber, form and color of the fiber elements. By the use of a plurality of fiber elements differing geometrically from one another in shape, a structured surface will be obtained which, because of the mixture of the staple fibers and the fiber elements prior to the construction of the fleece web, is moreover rapport-free. Therefore, it offers especially the use of fiber elements with another color than that of the staple fibers, whereby in particular surfaces can be obtained with different colored structures by the use of multicolored fiber elements.

Depending on the desired surface structure of the textile construction, there can be used as fiber elements, for example, yarns, threads, knobs (nap), spherical fiber-aggregate, stamped pieces and/or pieces of cut webs.

By the choice of cutting and stamping devices, fibers of any form can be produced, for example, with a circle-shaped, oval, rectangular or other polygonal form, so that almost every desired pattern can be produced. As feedstock for cut or stamped fibers, textile material is suitable of any form, for example, fleece webs or felts.

According to the invention, the possibly reinforced fleece web produced in this way is led to the side of the base layer opposite to the fiber elements, wherein the base layer consists preferably of polypropylene, polyester, polyamide and/or viscose fibers.

Preferably, the base layer is a carded and paneled material. As base layer, however, there can be used a wide variety of materials, including without limitation a fleece web, fabric, tufted material or felt, which, for example, may be reinforced/strengthened mechanically and/or chemically and/or thermally.

For the completion of the textile surface construction, the base layer is combined with the possibly reinforced fleece web, preferably by needling, particularly preferred by multiple needling.

In order to increase the strength of the textile surface-constructions, they can be reinforced additionally, for example, by impregnation with a binding agent.

According to a further embodiment of the present invention, at the lower side of the base layer, one or more additional base layers can be applied, for example, a dense layer, in order to give the textile surface construction further advantageous properties.

According to a further embodiment of the present invention, textile surface constructions are provided that are produced by the aforementioned process.

This surface construction consists of at least a base layer and a rapport-free, useful surface layer that is mesh-needled to the base layer to form an optically non-uniform surface construction. Besides the staple fibers, the surface layer contains a plurality of fiber elements that are distinguished in color, fiber properties and/or form from the staple fibers. While according to the invention, the fiber elements are arranged substantially at the upper side of the useful layer and stochastically distributed over the surface, rapport-free surfaces are obtained, that moreover are contrast-rich structures as well as optically have a non-uniform form. This is achieved because, during the production process, only a small deformation takes place or partial degradation of the structure of the fiber elements, preferably formed as fiber-aggregates, and these exist to a great extent in their original form at the visible surface. Moreover, the surface construction is characterized according to the invention by a high abrasion-resistance, whereby it can also be used as floor covering material or as similar long-wearing coverings, for example, as doormats in motor vehicles. By applying further base layers, for example, a dense layer, this surface construction can be optimally used for special applications, for example, as self-applying tiles.

Such surface constructions preferably are produced according to the process disclosed according to the invention, but not exclusively.

Further purposes, characteristics, advantages and possible applications of the invention will be apparent from the following description of preferred embodiments and the drawings.

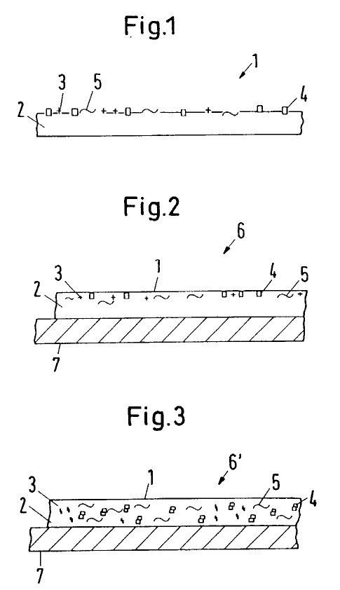

In FIG. 1 the represented fleece web, preferably a reinforced fleece web 1, according to the process of the invention, is produced as an intermediate product and consists of staple fibers 2 and three different fiber elements 3, 4, 5 of different colors. In order to obtain a multicolored structured pattern, there are employed, for example, three fiber elements 3, 4, 5 in a form that geometrically distinguishes from one from one another, i.e., spherically formed fiber elements 3, knob-shaped fiber elements 4 and thread-like fiber elements 5. The production of this fleece web 1 was carried out by an aerodynamic process, wherein previously prepared staple fibers 2 and fiber elements 3, 4, 5 first are mixed by a turbulent air-stream in a mixing device, and subsequently the mixture is blown by means of a laminar air-stream, for example, against a collecting surface that is preferably in the form of a rotating and perforated drum. Whereas the air is sucked off by the openings in the collecting surface, there is built up on the surface a random fleece, wherein, because of the different aerodynamic properties, the more compact and heavier fiber elements 3, 4, 5 come to lie predominantly at the side which is turned to the collecting surface, whereas on the other hand the lighter staple fibers 2 come to lie between and behind the fiber elements 3, 4, 5. Because of the small mechanical load during the aerodynamic process, the fiber elements 3, 4, 5 are present in the fleece substantially in their original form and structure. An optional reinforcing or strengthening of the fleece then can be realized by means of a mechanical and/or chemical and/or thermal process.

In FIG. 2 is represented the textile surface construction 6 according to the present invention, in which the reinforced fleece web 1, according to FIG. 1 has its lower side opposite to the fiber elements 3, 4, 5 applied to a base layer 7, e.g., in this case a one-layer fleece consisting of a needle fleece, and is needled to the base layer. The fiber elements 3, 4, 5 also are stochastically distributed over the surface even after the needling-step, and they are substantially in their original form at the visible side of the useful layer 1, so that a contrast-rich, multi-colored structured and also rapport-free pattern results on the surface of the useful layer 1.

In contrast to the above, the fiber elements 3, 4, 5 are produced, according to prior art, with a textile surface construction 6′, as shown in FIG. 3, wherein they are evenly distributed over the thickness of the useful layer and, moreover, as a result of the mechanical load to which they are subjected during the production process, especially in the needling of the base layer 7 to the useful layer 1, are strongly changed in form and structure. Therefore results a surface patterning with an optically uniform, color-weak and two-dimensional characteristic.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. A method for the production of a textile surface construction comprised of at least one base layer and a useful layer mesh-needled to the base layer, the useful layer having optically non-uniform, substantially report-free upper side and comprising staple fibers and a plurality of stochastically distributed fiber elements also having a predetermined and optionally different geometric form which is distinguished in its color and/or its fiber characteristics from the staple fibers, the method comprising:
a) forming a fleece web of staple fibers and said fiber elements, wherein the fiber elements are arranged predominantly on one side of the useful layer;
b) applying the side of the fleece web opposite to the fiber elements to the base layer; and
c) needle-working the fleece web to the base layer at least one time, in such a way that the fleece web constitutes the useful layer.

2. A method according to claim 1, wherein the fleece web is formed by an aerodynamic process.

3. A method according to claim 2, wherein the formation of the fleece web comprises blowing the staple fibers and the fiber elements in an air-stream against a perforated collecting surface.

4. A method according to claim 1, wherein the formation of the fleece web comprises a mechanical process using previously formed staple fibers.

5. A method according to claim 1, further comprising reinforcing the fleece web by a mechanical and/or thermal and/or chemical process.

6. A method according to claim 1, wherein the staple fibers and the fiber elements are mixed before forming the fleece web.

7. A method according to claim 6, wherein the mixing comprises aerodynamic mixing.

8. A method according to claim 1, wherein the staple fibers comprise a material selected from polypropylene, polyester, polyamide, viscose and a mixture thereof.

9. A method according to claim 1, wherein the fiber elements comprise different colors and/or fiber characteristics and/or different geometric forms.

10. A method according to claim 1, wherein at least a portion of the plurality of fiber elements comprise yarn, threads, knobs, spherical aggregates, stamped parts and/or cut parts of webs.

11. A method according to claim 10, wherein the stamped parts and/or the cut parts comprise a textile surface construction.

12. A method according to claim 1, wherein the base layer is selected from the group consisting of fleece, a web, a tufted web and felt.

13. A method according to claim 1, wherein the base layer comprises polypropylene, polyester, polyamide and/or viscose fibers.

14. A method according to claim 1, wherein the base layer is formed by mechanical carding.

15. A method according to claim 1, wherein, before applying the useful layer, the base layer is reinforced.

16. A method according to claim 15, wherein the reinforcing comprises a mechanical, thermal and/or chemically reinforcing process.

17. A method according to claim 1, further comprising providing to the base layer, at the opposite side of the useful layer, at least one further base layer.

18. A method according to claim 1, further comprising reinforcing the textile surface by impregnation with a binding substance.

19. A textile surface produced according to claim 1.

20. A textile surface according to claim 19 in the form of a floor covering material, a door-mat, a decoration material, a lining material or a surface covering material.
